(19) United States
(12) Patent Application Publication
(10) Pub. No.: US 2020/0030859 A1
(43) Pub. Date: Jan. 30, 2020

(54) DISSOLVABLE PIPELINE PIG AND METHODS FOR USING

(71) Applicant: Chevron U.S.A. Inc., San Ramon, CA (US)

(72) Inventor: Matthew Scott Bolen, The Woodlands, TX (US)

(21) Appl. No.: 16/044,971

(22) Filed: Jul. 25, 2018

(51) Int. Cl. B08B 9/055; F16L 55/42; F16L 55/46; F16L 55/38; B29C 45/00

(52) U.S. Cl. CPC B08B 9/0555; F16L 55/42; F16L 2101/12; F16L 55/38; B29C 45/0001; F16L 55/46

(57) ABSTRACT

A polymer pipeline pig is provided for cleaning the interior of a pipeline capable of completely dissolving in a fluid including oil, water and/or gas over a time period of from 4 days to 24 days and over a temperature range of from 100° F. to 250° F. The polymer is selected from polylactic acid, polyglycolic acid, poly(lactic-co-glycolic acid) and combinations thereof The pipeline pig can be launched into the interior of the pipeline, allowed to move through the interior of the pipeline in a fluid including oil and water, and dissolved over a time period of from 4 days to 24 days and over a temperature range of from 100° F. to 250° F. Thus, no pig receiving facility is needed.

### FIELD

The present disclosure relates generally to the field of pipeline pigs for cleaning out pipelines and other industrial, commercial and residential pipes. The present disclosure further relates to a dissolvable pipeline pig made up of a dissolvable polymer material.

### BACKGROUND

Conventional pipeline pigs for cleaning the interior of pipelines (also referred to as pipes, conduits, and lines) have a number of limitations. Referring to FIG. 1, shown is a simplified diagram of a prior art system in which a pipeline pig 4 can be launched from a pig launcher 14 into a pipeline 12. To launch the pig 4, the pig launching valve 15 is initially closed and valve 16 is opened. The end closure 17 can then be opened, the pig 4 is inserted and the end closure 17 again closed. The valve 16 is then closed, the pig launching valve 15 is opened, the pig 4 is launched into the pipeline 12. After the pig 4 is launched, the valve 16 is again opened and the launching valve 15 is again closed. After the pipeline pig 4 passes through the pipeline 12, the pig 4 is received by a pig receiver 8, also referred to as a pig catcher. The pig receiver 8 operates similarly to the pig launcher 14. The valve 18 and the pig receiving valve 19 are operated in the same way as valves 16 and 15, for receiving the pig 4 rather than launching the pig. The end closure 20 on the pig receiver 8 can be opened to remove the pig 4 from the pig receiver 8. The use of pipeline pigs 4 in subsea applications requires the installation of such costly equipment. In addition, conventional pipeline pigs 4 are frequently prone to getting stuck in pipelines 12, requiring costly intervention.

Dissolvable pipeline pigs have been introduced in effort to address the drawbacks of conventional pipeline pigs described above; however, problems exist with current dissolvable pipeline pigs in that they are dissolvable in either a fluid phase that is mostly water or a fluid phase that is mostly oil. There exists a need for a dissolvable pipeline pig that can dissolve in any combination of oil, water and gas.

### SUMMARY

In general, in one aspect, the disclosure relates to a pipeline pig for cleaning an interior of a pipeline. The pipeline pig has a shaped body having a diameter less than an inner diameter of the pipeline such that when the shaped body moves through the interior of the pipeline, the interior of the pipeline is cleaned. The shaped body is formed of a polymer capable of completely dissolving in a fluid including any combination of oil, water and gas over a time period of from 4 days to 24 days and over a temperature range of from 100° F. to 250° F.

In another aspect, the disclosure can generally relate to a method for cleaning an interior of a pipeline, including launching the pipeline pig described above into the interior of the pipeline and allowing the pipeline pig to move through the interior of the pipeline in the fluid including any combination of oil, water and gas over a time period of from 4 days to 24 days and over a temperature range of from 100° F. to 250° F. The pipeline pig thereby cleans the interior of the pipeline while being caused to dissolve. The pipeline pig is not received by a pig receiving facility as no pig receiving facility is needed.

### BRIEF DESCRIPTION OF THE DRAWINGS

These and other objects, features and advantages of the present invention will become better understood with reference to the following description, appended claims and accompanying drawings. The drawings are not considered limiting of the scope of the appended claims. Reference numerals designate like or corresponding, but not necessarily identical, elements. The drawings illustrate only example embodiments. The elements and features shown in the drawings are not necessarily to scale, emphasis instead being placed upon clearly illustrating the principles of the example embodiments. Additionally, certain dimensions or positionings may be exaggerated to help visually convey such principles.

FIG. 1 shows a simplified diagram of a pig launching and receiving facility in a prior art pipeline system.

FIG. 2 shows a simplified diagram of a pig launching and pipeline system using a dissolvable pipeline pig in an exemplary embodiment.

FIG. 3 shows alternative suitable shapes of pipeline pigs according to exemplary embodiments.

### DETAILED DESCRIPTION

In one embodiment, a pipeline pig is provided for cleaning an interior of a pipeline. The pipeline pig is formed of a polymer capable of completely dissolving in a fluid that contains oil, water and/or gas in a pipeline over a period of time and over a temperature range. Suitable polymers include polylactic acid (PLA), polyglycolic acid (PGA), poly(lactic-co-glycolic acid) (PGLA) and combinations thereof. Polylactic acid, polyglycolic acid and poly(lactic-co-glycolic acid) leave little to no residual after dissolving which is ideal for flow assurance in pipelines. In one embodiment, the pipeline pig (also referred to as the pig) contains no wax, e.g., paraffin wax. By avoiding the inclusion of wax, flow assurance problems may be avoided. The pig can contain minor amounts of other chemicals such as corrosion inhibitors or surfactants.

In one embodiment, the pipeline pig has a shaped body that can be formed by pouring the polymer in molten polymer form into a mold or by injection molding.

The shaped body of the pipeline pig can have an outer diameter that is less than the inner diameter of the pipeline such that when the pig moves through the interior of the pipeline, the interior of the pipeline is cleaned. In some embodiments, the outer diameter of the pipeline pig can be from 2 inches to 60 inches. The appropriate diameter will of course depend on the diameter of the pipeline.

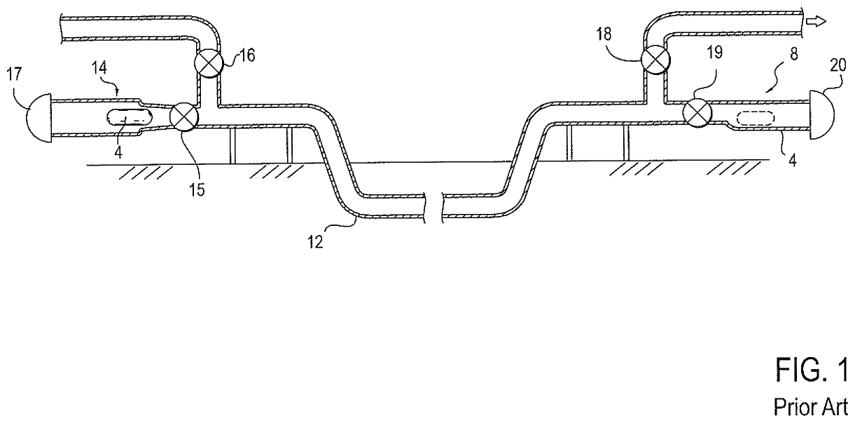

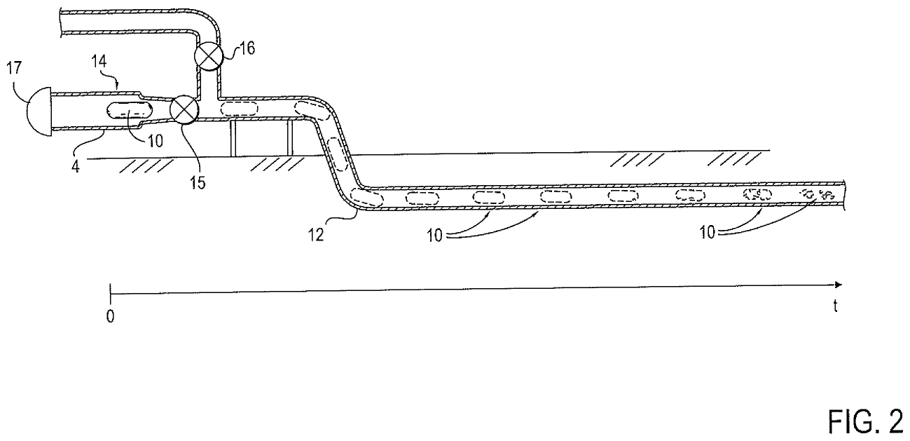

In one embodiment, as shown in FIG. 2, the pipeline pig 10 can be launched into a pipeline 12 by means of a pipeline launcher 14. In one embodiment, as in a conventional pig launching facility, to launch the pig 10, the pig launching valve 15 is initially closed and valve 16 is opened. The end closure 17 can then be opened, the pig 4 is inserted and the end closure 17 again closed. The valve 16 is then closed, the pig launching valve 15 is opened, the pig 10 is launched into the pipeline 12. After the pig 10 is launched, the valve 16 is again opened and the launching valve 15 is again closed. In other embodiments, the pig launching facility can be simpler or more complex. In the pipeline 12, the pig 10 can be in contact with fluids containing any combination of oil, water and gas. The polymer of the pig 10 can dissolve in any such combination, over a wide range of time periods and temperatures. As such, a pig receiving facility such as described in FIG. 1 is not needed in embodiments disclosed herein.

In one embodiment, as shown in FIG. 2, the pipeline pig 10 can completely dissolve in the fluid over a time period, t. The time period can be from 4 days to 24 days, even from 5 days to 20 days.

In one embodiment, the pipeline pig 10 can completely dissolve in the fluid over a temperature range of from 100° F. to 250° F., even from 125° F. to 200° F.

Advantageously, the dissolvable pipeline pig 10 is less prone to getting stuck in pipelines 12 than conventional pipeline pigs, since the dissolvable pig dissolves over time thus allowing the pig 10 to continue to move through the pipeline 12. Operationally, the dissolvable pipeline pigs 10 are more reliable than conventional pipeline pigs because if a dissolvable pig gets stuck, over time the pig 10 will become unstuck itself by dissolving without intervention.

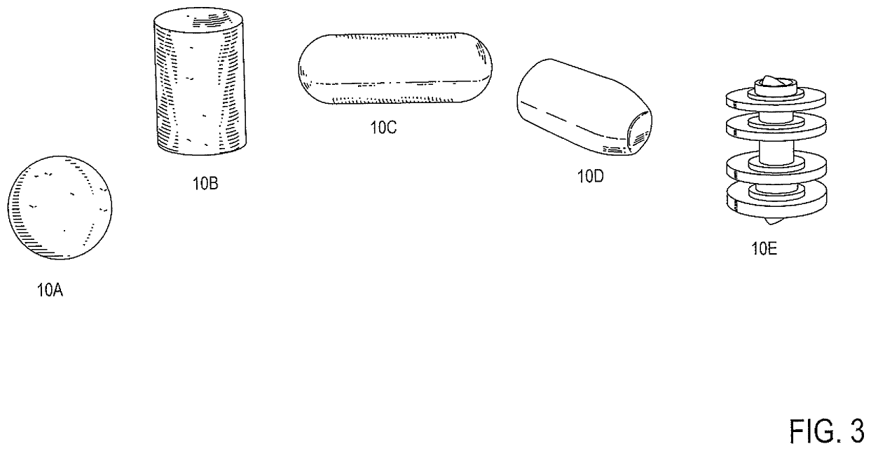

Referring to FIG. 3, the shaped body of the pig 10 can have any of a variety of suitable shapes. As nonlimiting examples, the shaped body of the pipeline pig 10 can have a substantially spherical body 10A, a substantially cylindrical body 10B, a substantially capsule-shaped body 10C, or a substantially bullet-shaped body 10D. In one embodiment, the shaped body of the pipeline pig 10 can have one or more peripheral fins around the circumference thereof 10E for scraping the interior wall of the pipeline 2.

Also advantageously, by using the dissolvable pipeline pig 10, the cost of the subsea pipeline architecture can be significantly reduced by eliminating the need for subsea pipeline pig receiver equipment. A dissolvable pipeline pig 10 eliminates the need for a pig receiver, also referred to as a pig catcher, thereby reducing capital and operating expense at pipeline facilities. By eliminating the pig catcher, subsea pipeline facility costs can be significantly reduced.

It should be noted that only the components relevant to the disclosure are shown in the figures, and that many other components normally part of a pipeline and pipeline pigging system are not shown for simplicity.

For the purposes of this specification and appended claims, unless otherwise indicated, all numbers expressing quantities, percentages or proportions, and other numerical values used in the specification and claims are to be understood as being modified in all instances by the term “about.” Accordingly, unless indicated to the contrary, the numerical parameters set forth in the following specification and attached claims are approximations that can vary depending upon the desired properties sought to be obtained by the present invention. It is noted that, as used in this specification and the appended claims, the singular forms “a,” “an,” and “the” include plural references unless expressly and unequivocally limited to one referent.

Unless otherwise specified, the recitation of a genus of elements, materials or other components, from which an individual component or mixture of components can be selected, is intended to include all possible sub-generic combinations of the listed components and mixtures thereof. Also, “comprise,” “include” and its variants are intended to be non-limiting, such that recitation of items in a list is not to the exclusion of other like items that may also be useful in the materials, compositions, methods and systems of this invention.

What is claimed is:

1. A pipeline pig for cleaning an interior of a pipeline, comprising a shaped body having a diameter less than an inner diameter of the pipeline such that when the shaped body moves through the interior of the pipeline, the interior of the pipeline is cleaned, the shaped body formed of a polymer capable of completely dissolving in a fluid comprising oil, water and/or gas over a time period of from 4 days to 24 days and over a temperature range of from 100° F. to 250° F.

2. The pipeline pig of claim 1 wherein the polymer is selected from the group consisting of polylactic acid, polyglycolic acid, poly(lactic-co-glycolic acid) and combinations thereof.

3. The pipeline pig of claim 1 wherein the shaped body contains no wax.

4. The pipeline pig of claim 1 wherein the shaped body comprises a substantially spherical body, a substantially cylindrical body, a substantially capsule-shaped body, or a substantially bullet-shaped body.

5. The pipeline pig of claim 1 wherein the shaped body comprises one or more peripheral fins capable of scraping the interior of the pipeline.

6. The pipeline pig of claim 1 wherein the diameter of the shaped body is from 2 inches to 60 inches.

7. The pipeline pig of claim 1 wherein the shaped body is formed by pouring the polymer in molten form into a mold or by injection molding.

8. A method for cleaning an interior of a pipeline, comprising launching the pipeline pig of claim 1 into the interior of the pipeline and allowing the pipeline pig to move through the interior of the pipeline in a fluid comprising oil, water and/or gas over a time period of from 4 days to 24 days and over a temperature range of from 100° F. to 250° F. thereby cleaning the interior of the pipeline and causing the pipeline pig to dissolve; wherein the pipeline pig is not received by a pig receiving facility.

9. The method of claim 8 wherein the polymer is selected from the group consisting of polylactic acid, polyglycolic acid, poly(lactic-co-glycolic acid) and combinations thereof.

10. The method of claim 8 wherein the shaped body contains no wax.

11. The method of claim 8 wherein the shaped body comprises a substantially spherical body, a substantially cylindrical body, a substantially capsule-shaped body, or a substantially bullet-shaped body.

12. The method of claim 8 wherein the shaped body comprises one or more peripheral fins capable of scraping the interior of the pipeline.

13. The method of claim 8 wherein the diameter of the shaped body is from 2 inches to 60 inches.

14. The method of claim 8 wherein the shaped body is formed by pouring the polymer in molten form into a mold or injection molding.

15. The method of claim 8 wherein the fluid comprises oil and water.

16. The method of claim 8 wherein the pipeline pig dissolves completely.
